(19) United States
(12) Patent Application Publication
(10) Pub. No.: US 2013/0075552 A1
(43) Pub. Date: Mar. 28, 2013

(54) Apparatus for Storing Container Lids

(71) Applicants: John L. Kenney, Las Vegas, NV (US); Jason S. Kenney, Las Vegas, NV (US); Brandon L. Kenney, Las Vegas, NV (US)

(72) Inventors: John L. Kenney, Las Vegas, NV (US); Jason S. Kenney, Las Vegas, NV (US); Brandon L. Kenney, Las Vegas, NV (US)

(21) Appl. No.: 13/241,067

(22) Filed: Sep. 22, 2011

(51) Int. Cl. A47B 96/07; A47B 96/06; F16B 47/00; F16M 13/00; F16M 13/02

(52) U.S. Cl. 248/205.3; 248/309.1; 248/224.8; 248/205.1

(57) ABSTRACT

An apparatus comprises a first member being configured for joining to a structure in a vertically oriented position. The first member comprises a first slot being configured for retaining a first edge of a lid for a container. A second member is configured for joining to the structure in a vertically oriented position opposing the first member. The second member comprises a second slot being configured for retaining a second edge of the lid for the container where the first member and the second member are operable for supporting the lid along a vertically oriented plane.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to storage devices. More particularly, the invention relates to a bracket device for storage of a pot or pan lid.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Pot and pan lids may be stored via a wide variety of ways. Storage of a pot/pan lid may be performed inside of a cabinet, on top of pot/pan, on top of counter and/or hanging from ceiling.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-C illustrates an example bracket, in accordance with an embodiment of the present invention;

FIG. 2 illustrates an enlarged view of a portion of a first vertical bar as discussed with reference to FIG. 1B, in accordance with an embodiment of the present invention;

FIG. 3 illustrates an example implementation for an example bracket, in accordance with an embodiment of the present invention;

FIG. 4 presents a picture of an example implementation for an example bracket, in accordance with an embodiment of the present invention;

FIG. 5 illustrates an example bracket, in accordance with an embodiment of the present invention;

FIG. 6 illustrates an example bracket, in accordance with an embodiment of the present invention; and

FIG. 7 illustrates example packaging for example brackets, in accordance with an embodiment of the present invention.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Embodiments of the present invention will be described for containing, storing and/or retaining lids associated with pots and pans.

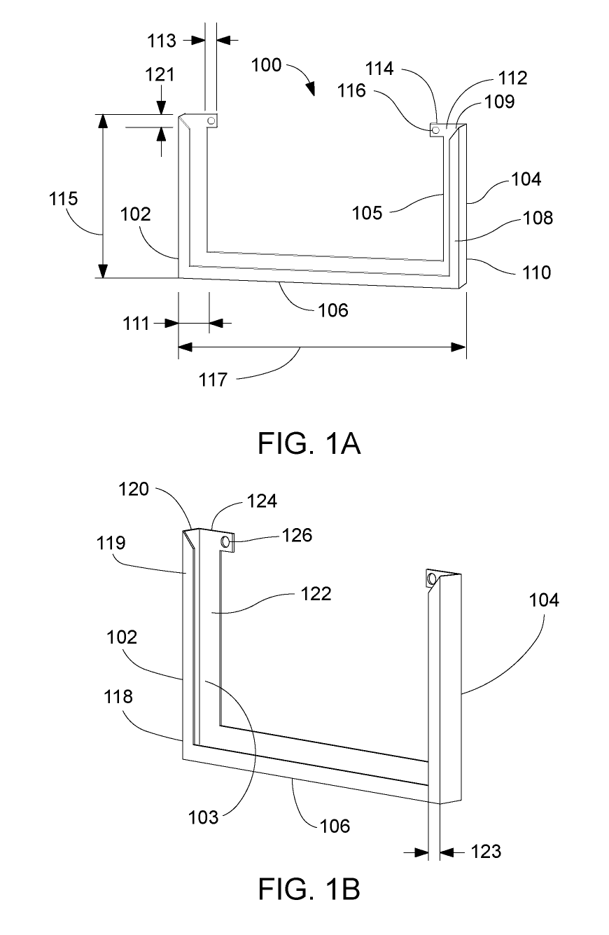

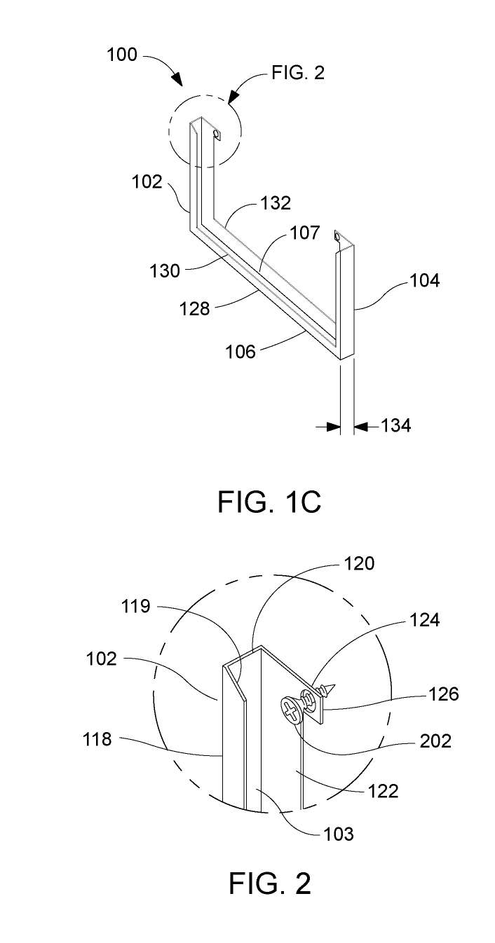

FIG. 1A illustrates an example bracket, in accordance with an embodiment of the present invention.

A bracket device 100 includes a first vertical bar 102, a second vertical bar 104 and a horizontal bar 106.

Bracket device 100 provides capability for retaining a lid device (not shown) for storage.

First vertical bar 102 retains a portion of a lid device, second vertical bar 104 retains a portion of a lid device and horizontal bar 106 retains a portion of a lid device.

Second vertical bar 104 includes a front retaining slat 108, a side slat 110 and a rear retaining slat 112.

A first edge of front retaining slat 108 connects to a first edge of side slat 110. A second edge of side slat 110 connects to a first edge of rear retaining slat 112. Front retaining slat 108, side slat 110 and rear retaining slat 112 are configured such that a slot 105 is made available.

Rear retaining slat 112 includes a tab 114. Furthermore, a hole 116 is located in tab 114.

Hole 116 provides a means for affixing second vertical bar 104 and bracket device 100 to a structure. As a non-limiting example, structure may be a cabinet door.

A slanted corner 109 providing a tapered corner may be configured for front retaining slat 108. Slanted corner 109 may be provided for any known angle of slant.

Furthermore, in some embodiments, slanted corner 109 may be configured with rounded corners. Slanted corner 109 may reduce efforts associated with inserting an item into bracket device 100.

In some embodiments, slanted corner 109 may not be configured for front retaining slat 108.

FIG. 1B further illustrates the example bracket as described with reference to FIG. 1A, in accordance with an embodiment of the present invention.

First vertical bar 102 includes a front retaining slat 118, a side slat 120 and a rear retaining slat 122.

A first edge of front retaining slat 118 connects to a first edge of side slat 120. A second edge of side slat 120 connects to a first edge of rear retaining slat 122. Front retaining slat 118, side slat 120 and rear retaining slat 122 are configured such that a slot 103 is made available.

Rear retaining slat 122 includes a tab 124. Furthermore, a hole 126 is located in tab 124.

Hole 126 provides a means for affixing first vertical bar 102 and bracket device 100 to a structure. As a non-limiting example, structure may be a cabinet door.

A slanted corner 119 is configured for front retaining slat 118.

FIG. 1C further illustrates the example bracket as described with reference to FIGS. 1A-B, in accordance with an embodiment of the present invention.

Horizontal bar 106 includes a front retaining slat 128, a bottom slat 130 and a rear retaining slat 132.

A first edge of front retaining slat 128 connects to a first edge of bottom slat 130. A second edge of bottom slat 130 connects to a first edge of rear retaining slat 132. Front retaining slat 128, bottom slat 130 and rear retaining slat 132 are configured such that a slot 107 is made available.

Bracket device 100 may be configured in a multiplicity of sizes in order to support a multiplicity of lid sizes.

As a non-limiting example, bracket device 100 may be fabricated of high-density polyethylene (HDPE) material.

As a non-limiting example, bracket device 100 may be configured in a U-bracket form-factor.

As an example, first vertical bar 102 and second vertical bar 104 may be configured for a length 115 (FIG. 1A) approximately equal to half the diameter of a lid (not shown) contained, stored and/or retained by bracket device 100. As a further example, for a thirteen-inch lid, length 115 (FIG. 1A) for first vertical bar 102 and for second vertical bar 104 is approximately six and one-half inches in length.

As an example, horizontal bar 106 may be configured for a length 117 (FIG. 1A) a quarter-inch in addition to the diameter of the lid contained, stored and/or retained by bracket device 100. As a further example, for a thirteen-inch diameter lid, length 117 (FIG. 1A) for horizontal bar 106 is approximately thirteen-inches and one-quarter inch in length.

Bracket device 100 includes a slot or track, as formed by slot 103, slot 105 and slot 107, for containing, storing and/or retaining a lid.

As a non-limiting example, rear retaining slat 112 (FIG. 1A), rear retaining slat 122 (FIG. 1B) and rear retaining slat 132 (FIG. 1C) have a width dimension, denoted by a width 111 (FIG. 1A), of approximately one inch in width. Furthermore, rear retaining slat 112, rear retaining slat 122 and rear retaining slat 132 may be mounted or affixed to a structure (e.g. cabinet door).

Tab 114 (FIG. 1A) extends from rear retaining slat 112 (FIG. 1A) and tab 124 (FIG. 1B) extends from rear retaining slat 122 (FIG. 1B). As a non-limiting example, the lengths of tab 114 and tab 124, denoted by a length 113 (FIG. 1A), are approximately one half of an inch. The heights of tab 114 and tab 124, denoted by a height 121 (FIG. 1A), are approximately one quarter of an inch.

As a non-limiting example, the width of front retaining slat 108 (FIG. 1A), front retaining slat 118 (FIG. 1B) and front retaining slat 128 (FIG. 1C) denoted by a width 123 (FIG. 1B), are approximately one-half inch.

As a non-limiting example, slanted corner 109 (FIG. 1A) and slanted corner 119 (FIG. 1B) may decline at a forty-five degree (45°) angle.

As a non-limiting example, the width of side slat 110 (FIG. 1A), side slat 120 (FIG. 1B) and bottom slat 130 (FIG. 1C), denoted by a width 134 (FIG. 1C), is approximately five-eighths of one inch.

FIG. 2 illustrates an enlarged view of a portion of first vertical bar 102 as discussed with reference to FIG. 1B, in accordance with an embodiment of the present invention.

A screw 202 traverses hole 126 for affixing first vertical bar 102 and bracket device 100 (FIGS. 1A-C) to a structure (not shown). As a non-limiting example, screw 202 may be configured as a Phillips-head screw.

Screw 202 may be configured of any known size or variation of screw capable of supporting the weight of bracket device 100 and associated contents. Furthermore, screw may be configured for a length such as to prevent protrusion through the front of cabinet doors.

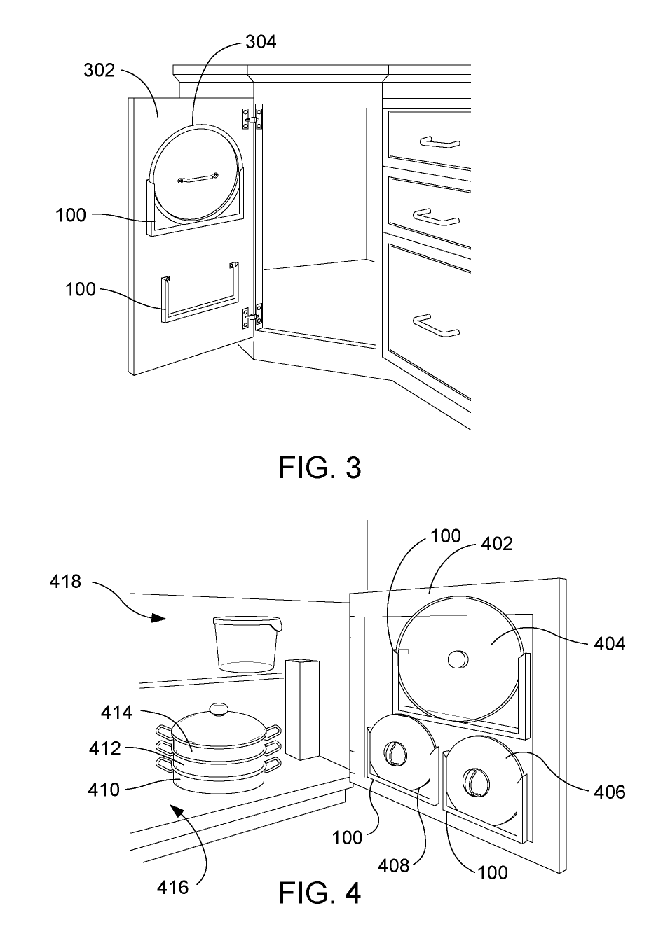

FIG. 3 illustrates an example implementation for an example bracket, in accordance with an embodiment of the present invention.

A multiplicity of bracket device 100 (FIGS. 1A-C) are affixed to a cabinet door 302.

A lid 304 slides into and is retained by bracket device 100 (FIGS. 1A-C).

Bracket device 100 may be attached to the interior plane of cabinet door 302.

Lid 304 may be placed within bracket device 100 for storage.

FIG. 4 presents a picture of an example implementation for an example bracket, in accordance with an embodiment of the present invention.

A multiplicity of bracket device 100 (FIGS. 1A-C) are affixed to a cabinet door 402.

A lid 404, a lid 406 and a lid 408 are retained by respective bracket device 100 (FIGS. 1A-C).

Lid 404 may be associated with a pan 410.

Lid 406 may be associated with a pan 412.

A pan 414 resides on top of pan 412. Furthermore pan 412 resides on top of pan 410.

Storage of lid 404 and lid 406 by respective bracket device 100 (FIGS. 1A-C) enables stacking of pans 410, 412 and 414 as illustrated. Furthermore, storage of lid 404 and lid 406 via respective bracket device 100 (FIGS. 1A-C) enables a space 416. As a result of using respective bracket device 100 (FIGS. 1A-C) for storage of lid 404 and lid 406 additional items may be stored in a cabinet 418 or more space may be provided around existing items.

Bracket device 100 (FIG. 1) provides storage of lids. Non-limiting examples for lids include pan lids, pot lids, container lids, bottle lids, bowl lids and potter lids.

Bracket device 100 (FIG. 1) frees up space via storage of lids associated with a structure. Furthermore, space previously consumed by lids is available as additional storage. Non-limiting examples for structure include cabinet door, door and wall.

Bracket device 100 (FIG. 1) provides convenient access to lids as lids may be stored adjacent to an accessible structure.

Bracket device 100 (FIG. 1) is a bracket for storage of lids. Furthermore, bracket device may be connected, mounted or attached to the interior plane of a structure (e.g. cabinet door).

Bracket device 100 (FIG. 1) includes a bracket and attachment device for connecting, mounting or attaching bracket device to a door (e.g. cabinet door). Non-limiting examples for attachment device include screws and sticky adhesive.

Bracket device 100 (FIG. 1) provides convenience for accessing lids.

Bracket device 100 (FIG. 1) reduces the shelf space needed for storage of lids, as lids are stored via previously unused space located adjacent to a structure.

Bracket device 100 (FIG. 1) improves organization for storage items associated with shelving via allocating unused space for lids and thereby freeing up space typically used for storage of lids.

As a result of lids stored via bracket device 100 (FIG. 1), pots and pans may be more readily stacked for efficient storage.

As a result of lids stored via bracket device 100 (FIG. 1), storage of lids on the top of pots and pans may be avoided thereby providing efficient stacking of pots and pans.

As a result of lids stored via bracket device 100 (FIG. 1), sliding and falling of lids may be avoided.

As a result of lids stored via bracket device 100 (FIG. 1), noise as a result of lids contacting other entities (e.g. pots, pans, etc.) may be reduced.

As a result of lids stored via bracket device 100 (FIG. 1), personal injuries associated with falling pot and pan lids may be avoided.

As a result of lids stored via bracket device 100 (FIG. 1), damages to lids associated with falling pot and pan lids may be avoided.

As a result of lids stored via bracket device 100 (FIG. 1), damage to floors, counters and other amenities associated with falling lids may be avoided.

As a result of lids stored via bracket device 100 (FIG. 1), the slipping and falling of lids and other cabinet contents when opening a cabinet door may be avoided.

As a result of lids stored via bracket device 100 (FIG. 1), the time for finding an appropriate lid and for preparing food items may be reduced.

As a result of lids stored via bracket device 100 (FIG. 1), the effort for finding a specific lid may be reduced.

Bracket device 100 (FIG. 1) may be used for storage of devices with a flat and/or rounded configuration. As a non-limiting example, a cutting board may be stored via bracket device 100 (FIG. 1).

Bracket device 100 (FIG. 1) may reduce the effort associated with storing lids.

Bracket device 100 (FIG. 1) uses space not typically associated with other uses.

Bracket device 100 (FIG. 1) may be attached to doors in such a way as to not interfere with the closing of the doors.

Bracket device 100 (FIG. 1) may provide an inexpensive means for increasing storage space.

Bracket device 100 (FIG. 1) requires little, if any, cabinet space and/or counter space.

Bracket device 100 (FIG. 1) may be employed for a multiplicity of vehicles. Non-limiting examples for vehicles employing bracket device 100 (FIG. 1) include recreational vehicles, boats, airplanes, trains and other vehicles with associated storage area(s).

Non-limiting examples for applications of bracket device 100 (FIG. 1) include restaurants and other food-establishments.

Installation of bracket device 100 (FIG. 1) may be performed by a person with average abilities. Furthermore, installation of bracket device 100 (FIG. 1) may be performed by attaching screws through device and into structure using a screwdriver. As a non-limiting example, two screws may be used for attachment.

Bracket device 100 (FIG. 1) may be fabricated of a multiplicity of materials. Non-limiting examples for materials include high-density polyethylene (HPDE), high-impact polystyrene (HIPS) aluminum, stainless steel, alloys and other metals.

Bracket device 100 (FIG. 1) may accommodate standard and non-standard pot and pan lid sizes. Non-limiting examples for standard pot and pan lid sizes include seven inch, eight inch, nine inch, ten inch, ten and one half inch and thirteen inch diameters.

In some embodiments, bracket device 100 (FIG. 1) may be coated with lining material. Non-limiting examples for lining material include low-density polyethylene (LDPE) and plasticized polyvinyl chloride (PVC).

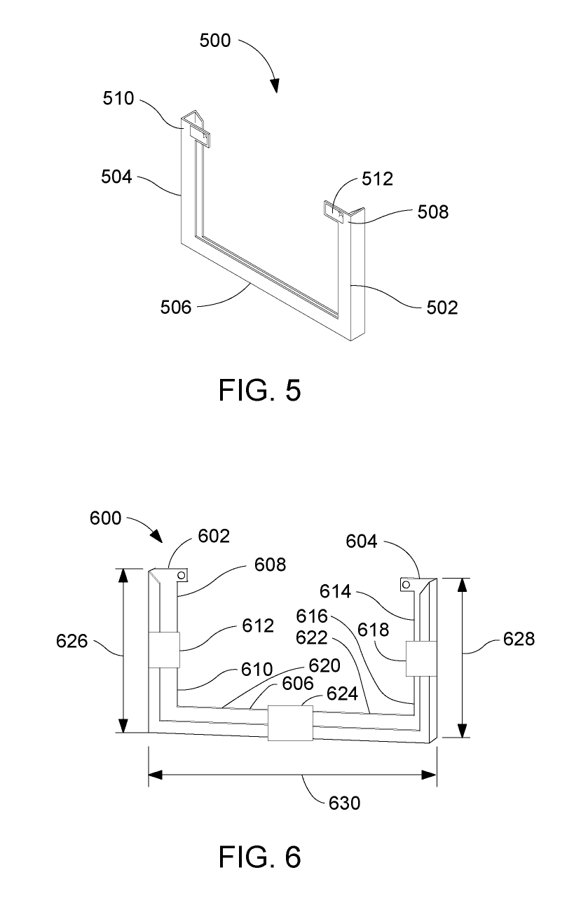

FIG. 5 illustrates an example bracket, in accordance with an embodiment of the present invention.

A bracket device 500 includes a first vertical bar 502, a second vertical bar 504 and a horizontal bar 506.

Bracket device 500 provides capability for retaining a lid device (not shown) for storage.

First vertical bar 502 retains a portion of a lid device, second vertical bar 504 retains a portion of a lid device and horizontal bar 506 retains a portion of a lid device.

An adhesive device 508 connects to first vertical bar 502.

An adhesive device 510 connects to second vertical bar 504.

Adhesive device 508 and adhesive device 510 may be configured as tabs.

Adhesive device 508 and adhesive device 510 adhere bracket device 500 to a structure (not shown).

As an example, a non-adhesive material 512 may be removed from adhesive device 508 thereby exposing an adhesive portion of adhesive device 508. Furthermore, the adhesive portion of adhesive device 508 may be attached to a structure for adhering bracket device 500 to the structure.

FIG. 6 illustrates an example bracket, in accordance with an embodiment of the present invention.

A bracket device 600 includes a first vertical bar 602, a second vertical bar 604 and a horizontal bar 606.

Bracket device 600 provides capability for retaining a lid device (not shown) for storage.

First vertical bar 602 retains a portion of a lid device, second vertical bar 604 retains a portion of a lid device and horizontal bar 606 retains a portion of a lid device.

First vertical bar 602 includes a top portion 608, a bottom portion 610 and an extension device 612.

Extension device 612 enables adjustment for a length dimension 626 of first vertical bar 602. Extension device 612 may be configured via any known means for extending or recessing top portion 608 and bottom portion 610.

Second vertical bar 604 includes a top portion 614, a bottom portion 616 and an extension device 618.

Extension device 618 enables adjustment for a length dimension 628 of second vertical bar 604. Extension device 618 may be configured via any known means for extending or recessing top portion 614 and bottom portion 616.

Horizontal bar 606 includes a left portion 620, a right portion 622 and an extension device 624.

Extension device 624 enables adjustment for a length dimension 630 of horizontal bar 606. Extension device 624 may be configured via any know means for extending or recessing left portion 620 and right portion 622.

The dimensions of bracket device 600 may be adjusted thereby enabling support for a multiplicity of dimensions for lids.

Bracket device 600 may be configured for supporting a multiplicity of lid sizes via adjustment of the length of horizontal bar 606, first vertical bar 602 and second vertical bar 604. Horizontal bar 606, first vertical bar 602 and second vertical bar 604 may be configured as telescoping. Furthermore horizontal bar 606, first vertical bar 602 and second vertical bar 604 may be configured via a multiplicity of sub-components. As a non-limiting example, horizontal bar 606, first vertical bar 602 and second vertical bar may be configured of two sub-components.

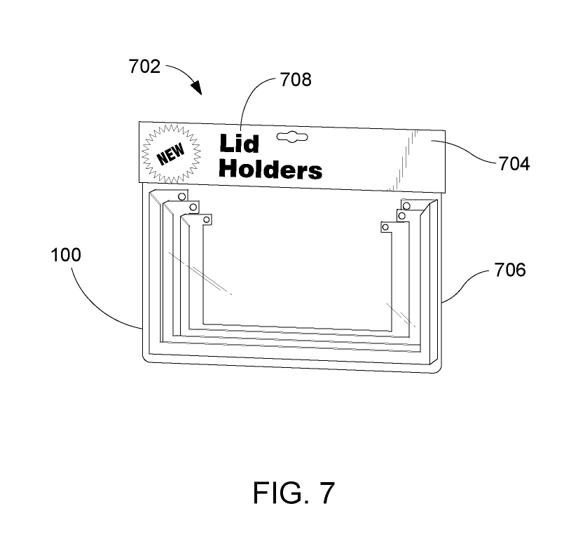

FIG. 7 illustrates example packaging for example brackets, in accordance with an embodiment of the present invention.

A multiplicity of brackets with a sampling denoted as bracket device 100 (FIGS. 1A-C) are contained within a containment package 702.

Containment package 702 includes an advertisement portion 704 and a containment portion 706.

Advertisement portion 704 may present information (e.g. a logo 708) for viewing.

As a non-limiting example, advertisement portion 704 may be fabricated out of cardboard material.

As a non-limiting example, containment portion 706 may be fabricated out of a clear plastic material.

As illustrated bracket devices may be configured for efficient containment via containment portion 706.

Containment package 702 may include screw 202 (FIG. 2). Furthermore, containment package 702 may not include screw 202 (FIG. 2).

As a non-limiting example, containment portion 706 may include a multiplicity of sizes for bracket device 100. As a non-limiting example, containment portion 706 may include a multiplicity of bracket device 100 of the same size.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods for storage of pot/pan lid via a bracket device according to the present invention will be apparent to those skilled in the art. The invention has been described above by way of illustration, and the specific embodiments disclosed are not intended to limit the invention to the particular forms disclosed. For example, the particular implementation for the material for fabrication may vary depending upon the particular type of cabinet used for mounting the bracket device. The bracket devices described in the foregoing were directed to home implementations; however, similar techniques for other implementations (e.g. automotive, marine, etc.) of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
a first member being configured for joining to a structure in a vertically oriented position, said first member comprising a first slot being configured for retaining a first edge of a lid for a container; and
a second member being configured for joining to the structure in a vertically oriented position opposing said first member, said second member comprising a second slot being configured for retaining a second edge of the lid for the container where said first member and said second member are operable for supporting the lid along a vertically oriented plane.

2. The apparatus as recited in claim 1, in which tops of said first slot and said second slot each comprises a slanted corner for facilitating entry of the lid into the slot.

3. The apparatus as recited in claim 1, in which said first member and said second member each comprises a tab being configured for joining to the structure.

4. The apparatus as recited in claim 3, in which said tabs extend perpendicularly from said members.

5. The apparatus as recited in claim 3, in which said tabs comprise holes for accepting screws for joining to the structure.

6. The apparatus as recited in claim 1, further comprising adhesive devices for joining said first member and said second member to the structure.

7. The apparatus as recited in claim 1, further comprising a third member being configured for joining, in a horizontal position, bottoms of said first member and said second member, said third member comprising a third slot being configured for retaining a third edge of the lid for the container.

8. The apparatus as recited in claim 7, in which said first slot, said second slot and said third slot each comprises a u-shaped slot.

9. The apparatus as recited in claim 8, in which said first member, said second member and said third member each comprises a back slat, a side slat and a front slat, said back slat, said side slat and said front slat being joined together to form said u-shaped slot.

10. The apparatus as recited in claim 9, in which said back slats comprise a width greater than a width of said front slats.

11. The apparatus as recited in claim 7, in which said first member, said second member and said third member each further comprises means for adjusting a length said member.

12. The apparatus as recited in claim 7, in which said first member and said second member are configured for joining to a cabinet door.

13. An apparatus comprising:
first means for retaining a first edge of a lid for a container, said first means being configured for joining to a cabinet door in a vertically oriented position;
a second means for retaining a second edge of the lid for the container, said second means being configured for joining to the cabinet door in a vertically oriented position; and
a third means for retaining a third edge of the lid for the container, said third means being configured for joining, said first means and said second means where said first means, said second means and said third means are operable for supporting the lid along a vertically oriented plane along the cabinet door.

14. The apparatus as recited in claim 13, further comprising means for adhesively joining said first means and said second means to the cabinet door.

15. The apparatus as recited in claim 13, further comprising means for adjusting a length of said first means, said second means and said third means.

16. An apparatus comprising:
a first member being configured for joining to a cabinet door in a vertically oriented position, said first member comprising a back slat, a side slat and a front slat, said back slat, said side slat and said front slat being joined together to form a u-shaped slot being configured for retaining a first edge of a lid for a container, said back slat comprising a width greater than a width of said front slat, said back slat further comprising a tab comprising a hole for accepting a screw for joining to the cabinet door, a top of said front slat comprising a slanted corner for facilitating entry of the lid into the slot;
a second member being configured for joining to the cabinet door in a vertically oriented position opposing said first member, said second member comprising a back slat, a side slat and a front slat, said back slat, said side slat and said front slat being joined together to form a u-shaped slot being configured for retaining a second edge of the lid for the container, said back slat comprising a width greater than a width of said front slat, said back slat further comprising a tab comprising a hole for accepting a screw for joining to the cabinet door, a top of said front slot comprising a slanted corner for facilitating entry of the lid into the slot; and
a third member being configured for joining, in a horizontal position, bottoms of said first member and said second member, said third member comprising a back slat, a side slat and a front slat, said back slat, said side slat and said front slat being joined together to form a u-shaped slot being configured for retaining a third edge of the lid for the container, said back slat comprising a width greater than a width of said front slat where said first member, said second member and said third member are operable for supporting the lid along a vertically oriented plane along the cabinet door.

17. The apparatus as recited in claim 16, in which said tabs extend perpendicularly from said back slats.

18. The apparatus as recited in claim 16, further comprising adhesive devices for joining said first member and said second member to the cabinet door.

19. The apparatus as recited in claim 18, in which said adhesive devices are further configured for joining said tabs to the cabinet door.

20. The apparatus as recited in claim 16, in which said first member, said second member and said third member each further comprises means for adjusting for adjusting a length said member.
